(19) United States
(12) Patent Application Publication
(10) Pub. No.: US 2004/0210460 A1
(43) Pub. Date: Oct. 21, 2004

(54) Marriage insurance for protecting against divorce

(75) Inventor: John K. McWilliams JR., Scottsdale, AZ (US)

Correspondence Address: U.S. PATENT CORPORATION, 7035 NORTH 23RD AVENUE, PHOENIX, AZ, 85021, US

(73) Assignee: MISCA, LLC, Scottsdale, AZ

(21) Appl. No.: 10/414,805

(22) Filed: Apr. 15, 2003

(51) Int. Cl. G06F 17/60

(52) U.S. Cl. 705/4

(57) ABSTRACT

Marriage support insurance is designed to protect the emotional, physical and financial well being of a married couple that holds a policy. As with many other kinds of insurance, premiums are paid during the term of the policy and benefits are provided to a beneficiary, usually one or both spouses. A first benefit of marriage support insurance is intended to encourage a marriage relationship by providing counseling resources to a married couple that holds a policy. A second benefit of marriage support insurance is to provide invested savings for a couple that remains married for the entire term of the policy by transferring the premiums paid for the policy into a marriage insurance savings account. A third benefit of marriage support insurance is financial assistance to one or both spouses should the marriage fail. Preferably, an educational campaign that informs the public about the devastating effects that divorces impose on individuals and on society is included in the method by which this insurance product is promoted.

### BACKGROUND OF THE INVENTION

The odds that a marriage will last for a lifetime are still favorable, but just barely. In the United States alone, there are about one million marriages that fail every year. Although the projections change slightly from year to year, an estimated 40 to 50 percent of new marriages will end in divorce. For those marriages that fail, divorce proceedings take about a year and are finalized after about seven years of marriage, on average. To obtain precise values for a particular year, the National Center for Health Statistics develops and attentively maintains marriage and divorce statistical calculations and projections. Dissolution of a marriage is clearly a risk, and insurance companies are in the business of providing protection against risk. People buy health, life, and disability insurance because they want to protect against unwanted life-changing events that could hurt those that they care about the most. Divorce is also an unwanted, life-changing event, but one that is rarely protected against. Although some individuals do require that their spouse-to-be enter into a prenuptial agreement, often on the advice of an attorney, these agreements are not uncommonly tainted with feelings of mistrust and unfairness.

Divorce insurance is an available alternative to reduce some of the risk associated with a failed marriage, but this insurance carries many of the negative connotations of a prenuptial agreement. In The Netherlands, for instance, paid-up insurance plans are available that will protect against divorce for a specified term, usually one year. The paid-up divorce insurance is set up to remain in force for the term with no need to pay additional premiums. Ironically, this divorce insurance is marketed for use as a wedding gift. Divorce insurance available in the United States is usually limited in design for the purpose of paying legal fees, child support, or alimony. In any case, the existing divorce insurances available today are targeted toward those that are either anticipating a divorce or for those that have already filed for a divorce.

### SUMMARY OF THE INVENTION

The present invention is a novel insurance product that is designed to do more than just payout in the unfortunate event that a marriage fails and results in yet another divorce. A marriage support insurance policy of the present invention will provide protection of the highly valued marital relationship through readily available critical counseling resources to every married couple that holds a policy, in addition to financial assistance should the marriage nevertheless fail. One goal of marriage support insurance is to prevent the failure of those marriages that will survive with the help of early counseling. The benefit to a policyholder that successfully remains married for a predetermined period of time, preferably 15 years, is that the premiums paid into the policy are transferred into a marriage insurance savings account as recognition of the couple's dedication to the marriage. Marriage support insurance is, therefore, an investment that provides valuable resources for maintaining a healthy marriage, as well as financial security no matter how the marriage fairs. With the help of marriage counselors, financial planners and divorce experts that can assist policyholders through the critical struggles of marriage, hopefully the divorce rate can be lowered and society will reap the benefits of stronger families.

Most preferably, the marriage support insurance method of the present invention includes a substantial educational campaign that will alert the general public to the devastating effects that divorces have statistically been shown to impose on the physical, emotional and financial health of those involved in a divorce, as well as on the approximately one million children every year that suffer as their parents struggle through, on average, a year long divorce. Educational campaigns have been effectively used to reduce high-risk activities such as substance abuse, drunk driving and domestic violence, among many other socially undesirable behaviors. Similarly, an educational campaign that emphasizes the risks involved with being a party to a dissolved marriage would be a public service, but at the same time would serve to create product loyalty, name recognition and positive corporate goodwill.

### BRIEF DESCRIPTION OF THE DRAWINGS

FIG. 1 is a flow chart portraying the various benefits of the marriage support insurance method of the present invention.

FIG. 2 is a timeline portraying a preferred method for providing the various benefits that become available to a policyholder.

### DETAILED DESCRIPTION OF THE INVENTION

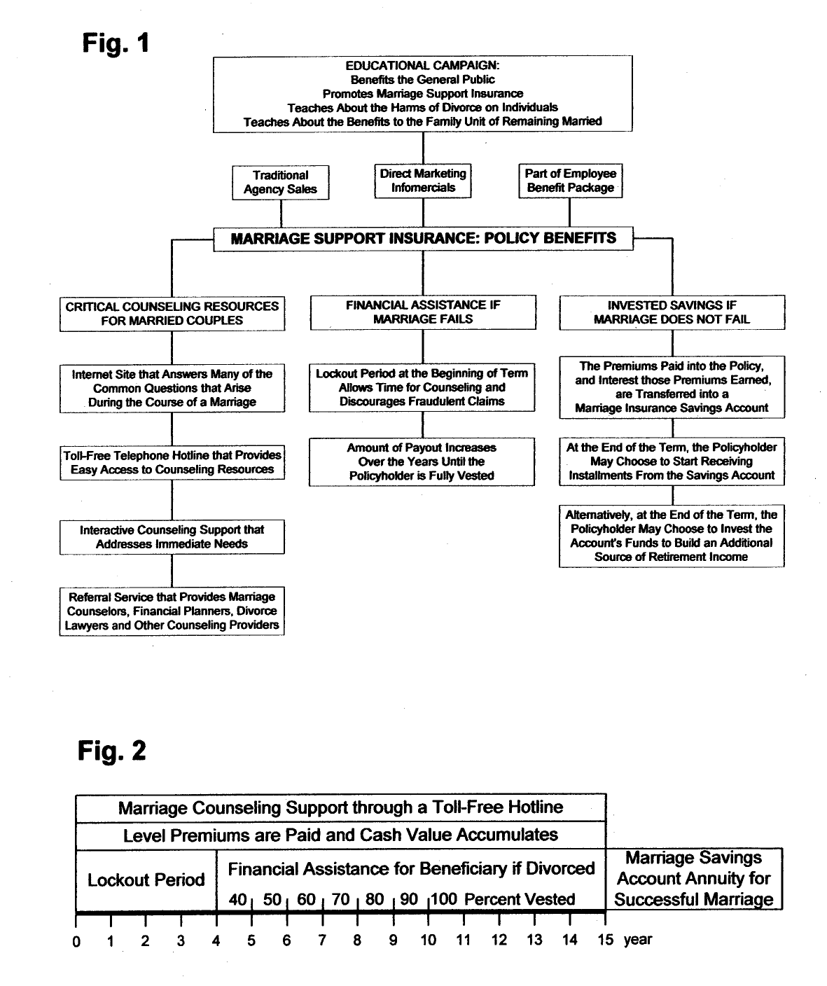

As shown in FIG. 1, there are three benefits included in a marriage support insurance policy of the present invention: critical counseling resources for policyholders, financial assistance for when policyholders cannot reconcile their marriage, and the benefit of invested savings for those policyholders who enjoy a successful marriage for a substantial period of time. Preferably, the marriage support insurance method also includes an educational campaign that will benefit the general public while promoting the insurance product. The most preferred method of providing marriage support insurance would be a complete combination of the benefits and methods that will be described in this detailed description, but it is understood that less complete marriage support insurance policies that include only selected benefits and methods described herein are encompassed by the present invention. Additionally, it is understood that an insurance underwriter is fully capable of determining what benefits an insurance carrier should extend to policyholders and what premiums should be charged, so there is no need for a discussion of statistics or management to teach the present invention.

The first benefit, critical counseling resources for policyholders, would be available to all policyholders at some level ranging from a minimum basic service to much more extensive and comprehensive support. Preferably, an internet site would be provided to answer many of the common questions that arise during the course of a marriage, as well as to teach about the individual harms of divorce and the benefits to the family unit of remaining married. Also, basic legal assistance could be provided, such as responding to general questions about divorce law, community property, custody, alimony, and the typical costs incurred during a divorce. Additionally, the insurance company would take an active roll in trying to help couples to reconcile their differences by providing counselors to talk clients through marital crisis situations and, hopefully, avoid a divorce outcome.

Although the level of interactive counseling support may vary between policies, policyholders would preferably receive counseling at critical times to address their immediate needs during a marital crisis situation. Once the critical interactive counseling has been provided, such as by calming the couple during a potentially harmful domestic situation, the support would shift to encouraging the couple to seek follow-up counseling from a marriage counselor, financial planner, and/or divorce expert in the locality of the policyholders. Contact information of nearby professional counseling support would be provided to the policyholders. Access to critical interactive counseling support would most preferably be by phone, such as through a toll-free marriage support insurance hotline. It is understood that the level of interactive counseling support that will be available to lower premium policyholders may not be as extensive as for those policyholders who are paying higher premiums.

The second benefit, financial assistance for those policyholders who cannot reconcile their marriage, would provide the policy's beneficiary with a payout in the event that the marriage fails. The point at which a marriage has failed will most likely be established by the issuance of a divorce decree, but alternative times, such as upon filing for divorce or permanent separation, may also be used as endpoints to establish the time that the marriage failed. The payout would be provided to a beneficiary in installments, preferably monthly checks, until a predetermined percentage of the face value of the policy is given to the beneficiary. The percentage of face value will depend on how long the marriage lasted before failing. The average divorce settlement in the United States is about $50,000, so, to restore the standard of living of a divorced person to the level they were at while married, a $50,000 policy is the most preferable face value of a policy. Wealthier individuals may want to invest in larger denomination policies, which will be discussed later.

To prevent fraudulent collection of the financial assistance benefit of marriage support insurance, and to prevent premature termination of a marriage that has not adequately sought the benefits of counseling, most marriage support insurance policies would include a lockout period. During the lockout period, most preferably set at 4 years, the paid in premiums accumulate cash value at a nominal interest rate and the policyholders have access to counseling support, but there is no payout for a couple that divorces during the lockout period. After the lockout period, the second benefit is available based on how well vested the policyholder is at the time the second benefit is collected.

By way of example, and not limitation, a policy with a 15 year term and a face value of $50,000 could have a lockout period of 4 years. As shown in FIG. 2, for the first 4 years the policyholder is 0% vested. At the end of the 4^{th} year, the policyholder is 40% vested. Similarly, the policyholder is 50% vested at the end of the 5^{th} year, 60% vested at the end of the 6th year, etc., and 100% vested at the end of the 10^{th} year. A couple that divorces at the end of the 5^{th} year would receive 50% of the face value of the policy, or $25,000, paid to the beneficiary in installments. Likewise, a couple that divorces after 12 years of marriage would receive 100% of the face value of the policy, or $50,000, paid to the beneficiary in installments.

The third benefit, invested savings for those policyholders who enjoy a successful marriage for a substantial and defined period of time, is a method of protecting the long term financial security of those couples who remain married for the full term of the policy. The full term is most preferably 15 years, but the length of a full term may be otherwise depending on the perceived needs of policyholders or the preferences of an insurance carrier or underwriter. At the end of the full term, a policyholder's paid-in premiums, along with any earned interest, are transferred into a marriage insurance savings account. At the request of the beneficiary, the marriage insurance savings account pays a stipulated sum of money to the beneficiary of the marriage support insurance policy at regular intervals as soon as all premiums have been paid and the term of the policy has ended. The marriage insurance savings account income continues to be paid for a predetermined number of years or for life. Alternatively, the beneficiary may invest the funds of the marriage insurance savings account, possibly to build another source of retirement income.

An additional component of the marriage support insurance method of the present invention is a substantial educational campaign that preferably utilizes direct marketing infomercials. In addition to selling policies, the direct marketing infomercials would preferably be half-hour televised educational programs, hosted by a recognizable and credible celebrity, that will alert the general public to the devastating effects that divorces have statistically been shown to have on the emotional, physical and financial well-being of individuals. Emphasis would be placed on the risks involved with being a party to a dissolved marriage and why marriage support insurance is a valuable investment that will benefit a marriage relationship. The educational campaign would also serve to create product loyalty and name recognition, as well as positive corporate goodwill. The actual sale of policies would, of course, additionally include the use of traditional agency sales, attaching to group policies, or providing an add-on for a traditional employee benefit package.

The premiums paid for marriage support insurance are preferably level, but the amount of premiums will be determined by demographics, such as the marriage history and age of the policyholders, so that the level premiums follow a tiered pricing structure. The premiums would preferably earn nominal interest that may be realized when the term of the policy has ended and the premiums are transferred into the marriage insurance savings account. Also, the face value of policies will carry different denominations depending on the level of benefits that are desired by policyholders. The standard face values are most preferably offered in the standard increments of the industry, such as $25,000, $50,000 or $100,000 increments.

Higher net worth individuals may prefer a different policy structure that is more suited to higher denomination policies. A high face value policy is usually going to be about ten times greater than a standard face value policy. High face value policies may, for example, require an initial deposit of 10% of the face value of the policy, thereby eliminating the need for a lockout period, so that the policyholder is partially vested the first year. Such a structure would be similar to a typical annuity investment, but the policyholder would still be required to pay premiums. Also, higher denomination policies would make it possible for an insurance company to provide substantially more counseling support than could effectively be provided to standard face value policyholders. Higher face value policies would be an effective substitute, or supplement, for a prenuptial agreement.

While a preferred form of the invention has been shown and described, it will be realized that alterations and modifications may be made thereto without departing from the scope of the following claims. For example, the beneficiary of a policy could be someone other than one of the policyholders, such as a child. Also, premiums could be paid at regular intervals, such as monthly or annually, or they could alternatively be prepaid in lump. Finally, there may be tax advantages to holding a marriage support insurance policy of the present invention, similar to the advantages of an IRA or whole life insurance policy, and it is anticipated that an insurance carrier will structure policies to allow policyholders and/or beneficiaries to benefit from such tax advantages.

What is claimed is:

1. A marriage support insurance product comprising:
At least one policyholder who is a spouse in a marriage;
At least one beneficiary of the marriage support insurance product;
A term, with a beginning and an end, during which time premiums are at least partially paid to an insurance carrier of the marriage support insurance product;
A critical counseling resources benefit that provides support for the marriage of the at least one policyholder;
A financial assistance benefit that provides a payout for the at least one beneficiary if the marriage fails prior to the end of the term; and
An invested savings benefit for the at least one beneficiary if the marriage does not fail prior to the end of the term of the marriage support insurance product, the invested savings benefit being realized when the premiums paid to the insurance carrier, along with any earnings those premiums realized during the term for the benefit of the at least one beneficiary, are transferred into a marriage insurance savings account.

2. The marriage support insurance product of claim 1 wherein the critical counseling resources benefit is characterized by a referral service that provides the at least one policyholder with information that will help them contact marriage counselors, financial planners, divorce lawyers and other counseling providers.

3. The marriage support insurance product of claim 1 wherein the critical counseling resources benefit is characterized by an internet site that provides answers to many of the common questions that arise during the course of a marriage.

4. The marriage support insurance product of claim 1 wherein the critical counseling resources benefit is characterized by interactive counseling support that addresses the immediate needs, during a marital crisis situation, of the at least one policyholder.

5. The marriage support insurance product of claim 1 wherein the critical counseling resources benefit is provided through a toll-free marriage support insurance hotline.

6. The marriage support insurance product in claim 1 wherein the financial assistance benefit is paid to the at least one beneficiary in installments, and wherein the size of the payout is determined by how well vested the at least one policyholder is substantially at the time that the marriage fails.

7. The marriage support insurance product of claim 1 wherein the financial assistance benefit is subject to a lockout period at the beginning of the term.

8. The marriage support insurance product of claim 1 further comprising an educational campaign that will benefit the general public, teach about the individual harms of divorce and the benefits to the family unit of remaining married, and promote the marriage support insurance product.

9. The marriage support insurance product of claim 8 wherein the educational campaign utilizes direct marketing infomercials.

10. A method of protecting against a divorce comprising the steps of:
providing a marriage support insurance policy to at least one policyholder who is a spouse in a marriage;
naming at least one beneficiary to the marriage support insurance policy;
defining a term, with a beginning and an end, during which time premiums are at least partially paid to an insurance carrier of the marriage support insurance policy;
providing a critical counseling resources benefit for the support of the marriage of the at least one policyholder;
providing a financial assistance benefit that pays an income to the at least one beneficiary for a period of time if the marriage fails prior to the end of the term; and
providing an invested savings benefit to the at least one beneficiary if the marriage does not fail prior to the end of the term, the invested savings benefit being realized when the premiums paid to the insurance carrier, along with any earnings those premiums realized during the term, are transferred into a marriage insurance savings account.

11. The method of claim 10 wherein the step of providing the critical counseling resources benefit is characterized by an interactive counseling support that assists the at least one policyholder during a marital crisis situation, and refers the at least one policyholder to a counselor that can provide the at least one policyholder with additional assistance that will help them with their marriage relationship.

12. The method of claim 10 wherein the step of providing the critical counseling resources benefit is characterized by providing an internet site that can answer many of the common questions that arise during the course of a marriage.

13. The method of claim 10 wherein the step of providing the critical counseling resources benefit is characterized by the utilization of a toll-free marriage support insurance telephone hotline.

14. The method of claim 10 wherein the step of providing the financial assistance benefit is characterized by providing a payout to the at least one beneficiary in installments, and wherein the size of the payout is determined by how well vested the at least one policyholder is substantially at the time that the marriage fails.

15. The method of claim 10 wherein the step of providing the financial assistance benefit is characterized by subjecting the financial assistance benefit to a lockout period at the beginning of the term.

16. The method of claim 10 further comprising the step of launching an educational campaign that will benefit the general public, teach about the individual harms of divorce and the benefits to the family unit of remaining married, and promote marriage support insurance policies.

17. The method of claim 16 wherein the educational campaign utilizes direct marketing infomercials.

18. The method of claim 10 further comprising the step of collecting an initial substantial premium at the beginning of the term, the initial substantial premium being capable of earning interest and substantially contributing to the amount of money transferred into the marriage insurance savings account at the end of the term.

19. An insurance product comprising:
At least one policyholder who is a spouse in a marriage;
At least one beneficiary of the insurance product;
A continuous period of time during which premiums are at least partially paid to an insurance carrier of the insurance product;
A critical counseling resources benefit that provides support for the marriage of the at least one policyholder; and
A financial assistance benefit having a predetermined face value that provides a payout for the at least one beneficiary if the marriage fails prior to the end of the term.

20. The insurance product of claim 19 wherein the financial assistance benefit is paid to the at least one beneficiary based on a schedule that establishes the percentage of the face value that will be paid out at any given time when the benefit is owed, the schedule substantially depending on how many premiums have been paid.
